(19) United States
(12) Patent Application Publication
(10) Pub. No.: US 2008/0138683 A1
(43) Pub. Date: Jun. 12, 2008

(54) Laminated layer fuel cell and method for manufacturing the same

(75) Inventor: Daishi Yoshikawa, Nagoya (JP)

Correspondence Address: OLIFF & BERRIDGE, PLC, P.O. BOX 320850, ALEXANDRIA, VA, 22320-4850, US

(73) Assignee: NORITAKE CO., LIMITED, NAGOYA (JP)

(21) Appl. No.: 11/979,614

(22) Filed: Nov. 6, 2007

(30) Foreign Application Priority Data
Nov. 13, 2006 (JP) 2006-307111

(51) Int. Cl. H01M 8/10; B05D 3/00

(52) U.S. Cl. 429/30; 427/58

(57) ABSTRACT

A laminated layer fuel cell includes a solid polymer electrolyte layer, a pair of catalyst layers, and a pair of gaseous diffusion electrode layers, one of the pair of catalyst layers and one of the pair of gaseous diffusion electrode layers being formed on one side of the solid polymer electrolyte layer, and the other of the pair of catalyst layers and the other of the pair of gaseous diffusion electrode layers being formed on the other side of the solid polymer electrolyte layer, wherein the one of the pair of catalyst layers and the one of the pair of the gaseous diffusion electrode layers constitute a composite electrode layer, and the composite electrode layer has an amount in a range of 10000 to 12000 ml·mm/cm²/min of air flow permeation in the thickness direction in a dried state.

This application is based on Japanese Patent Application No. 2006-307111 filed Nov. 13, 2007, the contents of which are incorporated hereinto by reference.

### BACKGROUND OF THE INVENTION

1. Field of the Invention

The present invention relates to a laminated layer fuel cell of which electrolyte layers are made of solid polymer material, and a method for manufacturing the same.

2. Description of Related Art

Fuel cells are electrochemical devices that convert chemical energy in fuels into electrical energy directly. In the fuel cells the fuels of reductants such as reformed hydrogen manufactured from hydrogen, methanol or fossil fuel are electrochemically oxidized by oxidants such as air or oxygen. They draw attention recently and are expected to be “clean” (namely, producing relatively little pollutant) sources of electrical energy that provide power in higher conversion efficiency than internal engines in silence and with minimal pollutant such as NOₓ, SOₓ and particuate matter (PM) causing air pollution. They are, for instance, expected to operate in replacement of power systems of the conventional automobiles, and in heat and electrical power providing systems and as dispersed electric power sources for such as residences.

The most common classification of fuel cells is by the type of electrolyte used in the cells and includes alkaline fuel cell (AFC), phosphoric acid fuel cell (PAFC), molten carbonate fuel cell (MCFC), solid oxide fuel cell (SOFC) and polymer electrolyte fuel cell (PEFC). The PAFC and PEFC using proton conductivity electrolyte can operate at high efficiency without suffering the thermodynamic limitation by Carnot cycle. It attains the theoretical efficiency of 83% at the temperature of 25° C. The PEFC, especially, attract attention because they are useful for power sources for minimal pollutant automobiles and high efficiency power generating systems, with improvement in its performance by recent development in electrolyte membrane and catalyst technologies.

The PEFC is constituted of a plurality of membrane electrode assemblies (MEAs) and separators disposed therebetween. The MEAs are laminated or bundled to form a conventional stack structure. The MEA includes a polymer electrolyte layer such as an ion exchange membrane that has an appropriate shape of such as a plate, and gaseous diffusion electrodes disposed on both sides of the polymer electrolyte layer, that is, the polymer electrolyte layer is sandwiched between the gaseous diffusion electrodes. A catalyst layer is disposed between the electrolyte layer and the gaseous diffusion electrode, or the gaseous diffusion electrode is constituted of a plurality of conductive particles having catalysts. The catalyst expedites ionization of hydrogen atoms at the fuel electrode, and recombination with oxygen atoms at the air electrode.

Research and development have mainly advanced with plate type PEFCs. They have been in general manufactured such that each member for each layer was respectively formed, and the layers were bonded by such as a single shaft hot press machine in thermocompression bonding. Appropriate thickness is required for strength in each member (or membrane) because sufficient strength is required for handling in the manufacturing process. The thickness for sufficient strength of each layer prevents sufficiently low ion conductivity resistance of the electrolyte membrane, and sufficiently low gaseous diffusion resistance in the electrode layer for the previous reason. WO 2004/012291 A, JP 3579885 B, JP 2004-047489 A, JP 2005-108770 A and JP 2005-235444 A disclose another manufacturing method of lamination of an electrode layer, an electrolyte layer and another electrode layer in which at least one layer is formed by coating or applying (referring to as a lamination manufacturing method, hereinafter). Although the thermocompression bonding manufacturing method is adopted only for the plate type PEFC, the lamination manufacturing method can be adopted for not only the plate type PEFC but also other PEFCs having any shape.

The PEFC by the lamination manufacturing method has a disadvantage of insufficient output because impregnation of electrolyte solution into pores of the porous electrode layer upon manufacturing of the electrode layer prevents gas permeation through the electrode layer and causes lowering in reactivity with the catalyst. Impregnation of the electrolyte solution not to perfectly cover the catalysts is allowed. No impregnation of the electrolyte solution into pores of the electrode layer and forming of an electrolyte layer on the surface achieve the ideal electrode layer.

WO 2004/012291 A discloses a manufacturing method such that catalyst electrode material is applied onto one surface of a tape shaped base material, then, before perfectly dried (namely, in the damp-dried condition), polymer electrolyte material is applied onto it, and after dried catalyst electrode material is applied onto it to form lamination. It asserts that this method can provide no lowering in electrical characteristics (it is supposed that the method can restrain lowering in gaseous diffusion performance at the electrode layer) because polymer electrolyte material is difficult to impregnate into a damp-dried catalyst electrode material layer, and impregnation of the electrolyte material into the electrode layer is restrained.

JP 3579885 B discloses a manufacturing method to integrally form the electrolyte layer and the catalyst electrode layer by hot pressing, after catalyst slurry is applied onto the electrolyte layer. It asserts that this method can restrain removal of the electrode layer from the electrolyte membrane at its interface. JP 2004-047489 A discloses a manufacturing method to apply predetermined kinds of ink (prepared material) that are simultaneously forced out from a nozzle for respectively forming a catalyst layer, an electrolyte layer and another catalyst layer, onto a base material. It asserts that this method can reduce proton resistance at the interfaces of the electrolyte layer and the catalyst layer, due to highly close contact between them.

JP 2005-108770 A discloses a manufacturing method to remove fluid components from electrolyte dispersion (solution) at the speed of not more than 25 mg·cm⁻²·h⁻¹, upon sequentially applying catalyst material, electrolyte dispersion (solution) and catalyst material onto a base material. It asserts that this method can increase mechanical strength of an electrolyte membrane. JP 2005-235444 A discloses a manufacturing method to apply catalyst ink including catalyst particles having a maximum diameter of not larger than 1 μm onto an electrolyte membrane, upon forming the catalyst layer on the electrolyte membrane. It asserts that this method can decrease damages on the electrolyte layer (membrane) caused by unevenness of the interface of the catalyst layer.

Although the manufacturing methods in the above described references of related art are intended to provide improvements of the PEFC, no methods can sufficiently restrain the above described impregnation of the electrolyte solution. WO 2004/012291 A is, for instance, intended to restrain impregnation of the electrolyte solution, but the method is hard to achieve stable processes due to difficulty to regulate the drying condition with appropriately damp-dried electrode layer. The methods of JP 3579885 B and JP 2005-235444 A are intended to form the catalyst layer on the independent electrolyte membrane instead of a solution-applied electrolyte layer, and accordingly, it is difficult to sufficiently reduce proton conductivity resistance. JP 2004-047489 A and JP 2005-108770 A disclose no method for improvement against impregnation of the electrolyte solution into the catalyst layer.

It is therefore an object of the present invention to provide a laminated layer fuel cell for sufficiently restraining impregnation of an electrolyte solution into an electrode layer, applying a solid polymer electrolyte layer onto the electrode layer, and accordingly, capable of high outputting, and a method for manufacturing the same.

### SUMMARY OF THE INVENTION

The object indicated above may be achieved according to a first aspect of the invention, which provides a laminated layer fuel cell including a solid polymer electrolyte layer, a pair of catalyst layers, and a pair of gaseous diffusion electrode layers, one of the pair of catalyst layers and one of the pair of gaseous diffusion electrode layers being formed on one side of the solid polymer electrolyte layer, and the other of the pair of catalyst layers and the other of the pair of gaseous diffusion electrode layers being formed on the other side of the solid polymer electrolyte layer, (a) wherein the one of the pair of catalyst layers and the one of the pair of the gaseous diffusion electrode layers constitute a composite electrode layer, and the composite electrode layer has an amount in a range of 10000 to 12000 ml·m/cm²/min of air flow permeation in the thickness direction in a dried state.

The object indicated above may be achieved according to a second aspect of the invention, which provides a method for manufacturing a laminated layer fuel cell including a solid polymer electrolyte layer, a pair of catalyst layers, and a pair of a gaseous diffusion electrode layers, one of the pair of catalyst layers and one of the pair of gaseous diffusion electrode layers being formed on one side of the solid polymer electrolyte layer, and the other of the pair of catalyst layers and the other of the pair of gaseous diffusion electrode layers being formed on the other side of the solid polymer electrolyte layer, the method comprising the steps of: (a) preparing a base material for the gaseous diffusion electrode layer which is made of porous conductive material to form the one of the pair of gaseous diffusion electrode layers; (b) forming the catalyst layer to form a base material for the gaseous diffusion electrode layer accompanied with the one of the pair of catalyst layers on its one side, so as to have an amount in a range of 10000 to 12000 ml·m/cm²/min of air flow permeation in the thickness direction in a dried state; and (c) forming the solid polymer electrolyte layer by applying electrolyte solution onto the catalyst layer of the base material for the electrode layer accompanied with the one of the pair of catalyst layers.

These provide high density of the electrode layer accompanied with the catalyst layer in the first aspect of the present invention and of the base material for an electrode accompanied with the catalyst layer in the second aspect of the present invention, by the above described range of amounts of air flow permeation in the thickness direction in the dried state. Accordingly, impregnation into the electrode layer or the base material for an electrode (hereinafter, both referred to as the electrode layer if distinction is not required) is preferably restrained upon forming the electrolyte layer by application of the electrolyte solution on one side. This provides the laminated layer fuel cell with high output since impregnated electrolyte restrains lowering in the gaseous diffusion performance and the reactivity with catalyst of the electrode layer. The above range of amount of air flow permeation of the electrode layer accompanied with the catalyst layer is required because the amount of below 10000 ml·m/cm²/min causes insufficient gaseous diffusion performance irrespective of impregnation of the electrolyte solution, and the amount of over 12000 ml·m/cm²/min causes incapability of restraining of impregnation of the electrolyte solution.

Perfect prevention from impregnation of the electrolyte solution into the electrode layer with the catalyst layer is ideally preferred, and impregnation of imperfect covering the surface is allowable. In the present invention the amount of air flow permeation is measured under the pressure of 50 kPa by a perm porometer. The “dried state” is a state with a solvent excluded in the degree causing no change of mass, the solvent being included in the diffusion solution of the catalyst upon forming the catalyst layer on the electrode layer. In the present invention mutual independency of the catalyst layer and the electrode layer (or electrode base material), that is, the structure of the solid polymer electrolyte layer interposed between the electrode layers with each catalyst layer therebetween, is not requisite. The structure having a layer functioning as the catalyst layer and a layer functioning as the electrode layer is sufficient for an embodiment of the present invention. For instance, the structure having one layer functioning as both the catalyst layer and the electrode layer is sufficient. Concretely, a catalyst electrode made from powder of conductive material such as carbon having catalyst that functions as both the catalyst layer and the electrode layer and that is integrally formed, or an electrode layer impregnated with catalyst is sufficient.

The object indicated above may be achieved according to a third aspect of the invention, which provides the method according to the second aspect of the invention, wherein the gaseous diffusion electrode layer is formed in heat treatment of slurry including carbon fibers, conductive polymer and thermosetting resin, at or below 200° C. This provides the laminated layer fuel cell with higher output by higher current density.

The object indicated above may be achieved according to a fourth aspect of the invention, which provides the method according to the second or third aspect of the invention, wherein the electrolyte solution has viscosity in the range of 600 to 1000 mPa·s. This provides the laminated layer fuel cell with further higher output by further restraining of impregnation into the electrode layer with viscosity in the preferred range. The electrolyte solution having over 600 mPa·s in viscosity is preferred for further restraining impregnation, irrespective of the electrolyte having the amount of air permeation in the above disclosed range. The electrolyte solution having the viscosity of over 1000 mPa·s prevents application of the solution in uniform thickness on the surface of the catalyst layer due to its excessive high viscosity.

The object indicated above may be achieved according to a fifth aspect of the invention, which provides the method according to one of the second to fourth aspects of the invention, wherein the electrolyte solution applied onto the catalyst layer is treated in drying treatment for a predetermined period of time at room temperature, and then, is heated to harden the electrolyte solution at a higher temperature, in the step of forming the solid polymer electrolyte layer. This further restrains impregnation into the electrode layer by preferably restraining lowering in viscosity of the electrolyte solution accompanied with an increase in temperature due to the drying treatment. The drying treatment at a high temperature just after the application of the solution causes the tendency of impregnation of the electrolyte solution having lowered viscosity into the electrode layer if its decreasing speed in viscosity is higher than the evaporating speed of the solvent, irrespective of regulated viscosity at a preferred value in which impregnation is difficult to occur upon application of the electrolyte solution. Hardening of the electrolyte layer at a high temperature after removing the solvent in a degree in the drying treatment at the room temperature causes to overcome this disadvantage. The period of time for the drying treatment may be appropriately determined with due regard to volatility of the solvent. Propanol, for instance, requires the drying treatment for only about 30 minutes.

The object indicated above may be achieved according to a sixth aspect of the invention, which provides the method according to one of the second to fifth aspects of the invention, wherein the step of forming the catalyst layer includes the steps of: (a-1) impregnating the base material with a diffusion solution for impregnating with catalyst in which catalyst material for forming the catalyst layer is diffused; and (a-2) applying the diffusion solution for impregnating with catalyst in which the catalyst material is diffused in solution including a predetermined electrolyte, onto the side of the base material which is impregnated with the catalyst, to form the one of the pair of catalyst layers. This causes lowering in the air flow permeation rate of the base material for the electrode due to previous impregnation with catalyst, and the regulated air flow permeation rate of the base material for the electrode with the catalyst layer in the range described above, due to further forming of the catalyst layer thereon. And the catalyst previously impregnated into the electrode base material causes further restraint of impregnation of the electrolyte solution into the electrode layer upon forming the electrolyte layer, to provide the PEFC having further higher output. The solution including electrolyte that is the solvent of the diffusion solution for catalyst application may be any including the same one for forming the electrolyte layer and others.

The object indicated above may be achieved according to a seventh aspect of the invention, which provides the method according to one of the second to fifth aspects of the invention, wherein the step of forming the catalyst layer includes the steps of: (a-1) forming an intermediate layer having a smaller diameter of a pore than that of the base material for an electrode, by applying a conductive particle diffusion solution in which a predetermined conductive particle is diffused in fluid synthetic resin, onto the side of the base material for an electrode; and (a-2) forming the one of the pair of catalyst layers, by applying the diffusion solution for applying catalyst in which the catalyst material for forming the catalyst layer is diffused in solution including a predetermined electrolyte, onto a surface of the intermediate layer. This causes lowering in the air flow permeation rate due to the intermediate layer formed on a side of the base material for the electrode, and the regulated air flow permeation rate of the base material for the electrode with the catalyst layer in the range described above, due to further forming of the catalyst layer thereon. “Fluid synthetic resin” described above may be not only synthetic resin that is fluid in itself but also synthetic resin dissolved in an appropriate solvent. The above intermediate layer may be formed in any method, for instance, screen printing.

The object indicated above may be achieved according to an eighth aspect of the invention, which provides the method according to one of the second to fifth aspects of the invention, wherein the step of forming the catalyst layer includes the step of: (a-1) forming the one of the pair of catalyst layers, by more than once applying the diffusion solution for impregnating with catalyst in which the catalyst material for forming the catalyst layer is diffused in solution including a predetermined electrolyte, onto the side of the base material, and drying the base material. This causes preferable restraint of impregnation of the electrolyte solution that is applied on the catalyst layer into the electrode layer through the catalyst layer, due to the regulated air flow permeation rate in the range described above, with the thicker catalyst layer than a catalyst layer that is formed by a single application of the solution.

Preferably, the air flow permeation rate may be determined in a range of 10000 to 12000 ml·m/cm²/min in the first and second aspects of the invention. This causes further higher output by further restraint of lowering in gaseous diffusion performance due to further restraint of impregnation of the electrolyte solution.

Preferably, the electrolyte solution may be regulated in concentration in the range of 32-35%. This causes preferable restraint of impregnation of the electrolyte solution into the electrode layer by its viscosity described above, due to regulation in concentration in an appropriate range for the electrolyte solution. The concentration of the solution is preferably not less than 32% to restrain impregnation of the electrolyte solution since lower concentration of the solution causes lower viscosity. The concentration of the solution is preferably not more than 35% to provide sufficient uniformity in the formed membrane since higher concentration of the solution causes higher viscosity.

Preferably, the above base material for the electrode may be made of, for instance, carbon fiber paper (namely, carbon paper), carbon fiber cloth (namely, carbon cloth), unwoven fabric including carbon nanofiber and/or carbon nanocone, or unwoven fabric impregnated with conductive material. The base material for the electrode may be expected to introduce fuel gas or air into the catalyst layer and onto the surface of the electrolyte layer, and to obtain both high gaseous diffusion performance and high conductivity to have the produced current. Any materials for constitution may be available, not limited to certain kinds of them, provided they meet these conditions. In general, the materials described above are used.

Conventional various materials are available, not limited to certain kinds of them, for materials for the solid polymer electrolyte layer. They may be, for instance, homopolymer or copolymer of monomer having an ion exchange group such as —SO₃H group, copolymer of mononer having an ion exchange group and another monomer capable of copolymerizing with the former monomer, homopolymer of monomer having a functional group that may be converted to an ion exchange group in a post treatment such as hydrolysis (namely, a precursory functional group of an ion exchange group), and copolymer (proton conductive polymer precursor) that is treated in the same post treatment. And the following materials may be, for instance, available for the polymer electrolyte: perfluoro type proton conductive polymer such as perfluorocarbonsulfonic acid resin; perfluorocarboncarboxylic acid resin membranes; sulfonic acid type polystyrene-graft-etylenetetrafluoroetylene (ETFE) copolymer membranes; sulfonic acid type poly (trifluorostyrene)-graft-ETFE copolymer membranes; polyetheretherketone (PEEK) sulfonic acid membranes; 2-acrylamide-2-methylpropanesulfonic acid (ATBS) membranes; and hydrocarbon membranes.

Since the laminated layer fuel cell according to the first aspect and the manufacturing method according to the second aspect of the present invention require no pressurizing step such as hot pressing, they are available for not only the plate type PEFC but also various kinds of PEFCs in their shapes.

### BRIEF DESCRIPTION OF THE DRAWINGS

FIG. 1 illustrates a plate type membrane electrode assembly (MEA) in a cross sectional view according to one embodiment of the present invention.

FIG. 2 illustrates a diagram of the MEA in FIG. 1 showing an interface of the catalyst layer and the electrode layer, and its surroundings in an enlarged view.

FIG. 3 illustrates a diagram of the MEA in FIG. 1 showing an interface of the catalyst layer and the electrode layer, and its surroundings according to another embodiment in an enlarged view.

FIG. 4 illustrates a diagram of the MEA in FIG. 1 showing an interface of the catalyst layer and the electrode layer, and its surroundings according to another embodiment in an enlarged view.

FIG. 5 illustrates a diagram showing an example of the process for manufacturing the MEA in FIG. 2.

FIG. 6 illustrates a diagram showing an example of the process for manufacturing the MEA in FIG. 3.

FIG. 7 illustrates a diagram showing an example of the process for manufacturing the MEA in FIG. 4.

FIG. 8 illustrates an enlarged sectional view prepared on the basis of an electron micrograph around an interface of the catalyst layer and the electrolyte layer of the MEA in FIG. 4.

FIG. 9 illustrates an enlarged sectional view prepared on the basis of an electron micrograph around an interface of the catalyst layer and the electrolyte layer of the MEA of the comparative example.

FIG. 10 illustrates the relationship of the voltage and the current density for plotting results of the measurement for MEAs.

FIG. 11 illustrates the relationship of the voltage and the current density by plotting results of the measurement for CP-2 samples at predetermined temperatures.

FIG. 12 illustrates the relationship of the pressure on the surface and the air flow permeation rate of each sample of the electrode with the catalyst layer thereon.

FIG. 13 illustrates the relationship of the air flow permeation rate and the current density of the measurement by 0.6 V and at 60° C.

FIG. 14 illustrates the relationship of concentration, temperature and viscosity of the electrolyte solution.

### DETAILED DESCRIPTION OF EXEMPLARY EMBODIMENTS

Hereinafter, there will be described the present invention by reference to the drawings. The figures are appropriately simplified or transformed, and all the proportion of the dimension and the shape of a portion or member may not be reflective of the real one in the following embodiments.

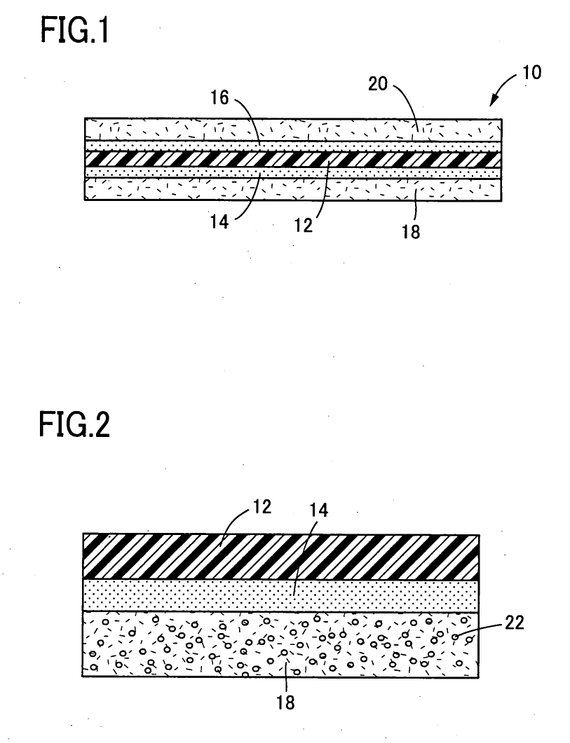

FIG. 1 illustrates a membrane electrode assembly (MEA) 10 of a plate type in a cross sectional view according to an embodiment of the present invention. The MEA 10 includes a thin layer of an electrolyte membrane 12 that expands as a plate, catalyst layers 14, 16, and gaseous diffusion electrodes 18, 20. The catalyst layers 14, 16 are respectively disposed on each surface of the electrolyte membrane 12, and the gaseous diffusion electrodes 18, 20 are respectively disposed on each surface of the catalyst layers 14, 16 as shown in FIG. 1. That is, the electrolyte membrane 12 is interposed between the catalyst layers 14, 16, and a set of the electrolyte membrane 12 and the catalyst layers 14, 16 is interposed between the gaseous diffusion electrodes 18, 20. One MEA 10 may constitute one PEFC, but it provides only low output. And, then, a plurality of MEAs 10 that are laminated and separators disposed between the MEAs 10 usually constitutes one PEFC.

The electrolyte membrane 12 is made of polymer electrolyte having proton conductivity, and, for instance, has the thickness of about 75 μm. Perfluorosulfonic acid membrane of such as DuPont™ Nafion® membranes or Dow® membranes of the Dow Chemical Company is used for the electrolyte membrane 12.

The catalyst layers 14, 16 are made of, for instance, catalyst powder and polymer electrolyte. The catalyst powder is, for example, Pt-having carbon black (hereinafter, referring to as “Pt/C catalyst”), that is, spherical carbon powder having catalyst such as platinum (Pt). The polymer electrolyte is made of such as perfluorosulfonic acid as the material of the electrolyte layer 12. The catalyst layers 14, 16, for instance, have the thickness of about 50 μm.

The gaseous diffusion electrodes 18, 20 are porous conductors of electricity that respectively have the thickness of, for instance, about 380 μm, and they allow gas or air to easily permeate through them between the outwardly facing surfaces and the opposite surfaces of them, that is, the surfaces on the sides of the catalyst layer 14, 16. These gaseous diffusion electrodes 18, 20 are made of such as carbon papers, carbon clothes, or unwoven fabrics including conductive particles or fibers of such as carbon. The gaseous diffusion electrode 20 may have such as a synthetic resin structure including, for instance, carbon fibers that are mutually tangled.

FIG. 2 illustrates a diagram of the MEA 10 in FIG. 1 showing an interface of the catalyst layer 14 and the gaseous diffusion electrode 18, and its surroundings in an enlarged view. A plurality of the same or similar catalyst particles 22 as or to Pt/C catalyst included in the catalyst layers 14, 16 are included and diffused in the gaseous diffusion electrode 18 in this embodiment, that is, the particles 22 are present everywhere in the electrode 18 not only in the longitudinal and transversal directions but in the width direction. The catalyst particles 22 occupy pores in the porous gaseous diffusion electrode 18, and provide voids of short diameters made by the pores and the particles 22. Although the gaseous diffusion electrode 20 does not include the catalyst particles 22 in this embodiment, the electrode 20 may include the particles 22.

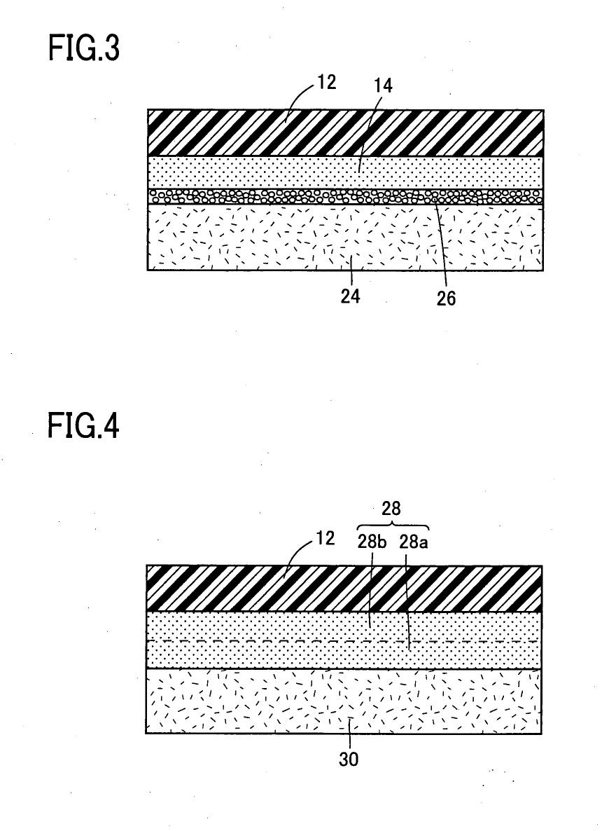

FIG. 3 illustrates a diagram of the MEA 10 in FIG. 1 showing a lamination structure of another catalyst layer 14 and a gaseous diffusion electrode 24 instead of the lamination structure of the catalyst layer 14 and the gaseous diffusion layer 18 in FIG. 2. An intermediate layer 26 is interposed between the catalyst layer 14 and the gaseous diffusion electrode 24 in this embodiment. The gaseous diffusion electrode 24 is made of such as carbon paper as well as, for instance, the gaseous diffusion electrode 18, but the electrode 24 does not include catalyst particles 22. The intermediate layer 26 has the thickness of, for instance, about 50-100 μm, is a porous conductor layer that has about 0.2 μm of void diameters in which conductor particles are bonded to surfaces of pores by such as synthetic resin to form voids, and has porosity of about 37%. Accordingly, the intermediate layer 26 has smaller void diameters than the gaseous diffusion electrode 24 that has about 35 μm of void diameters and porosity of about 79%. Such as carbon black is available for the conductor particles, and, for instance, resol type phenol resin is available for the synthetic resin.

FIG. 4 illustrates a diagram of the MEA 10 in FIG. 1 showing a lamination structure of another catalyst layer 28 and a gaseous diffusion electrode 30 instead of the lamination structure of the catalyst layer 14 and the gaseous diffusion layer 18 in FIG. 2. The catalyst layer 28 and the gaseous diffusion electrode 30 are directly laminated as well as in FIG. 2 in this embodiment, that is, no layer is interposed between them. The catalyst layer 28 includes catalyst powder and polymer electrolyte as well as the catalyst layer 14, and is constituted of two layers, that is, a catalyst layers 28a, 28b that are piled up to have a thickness of, for instance, about 100 μm that is thicker than that of the catalyst layer 14 in this embodiment. The catalyst layer 28 is denser than the catalyst layer 14, that is, the layer 28 has smaller volume of pores (voids) in total within than the layer 14.

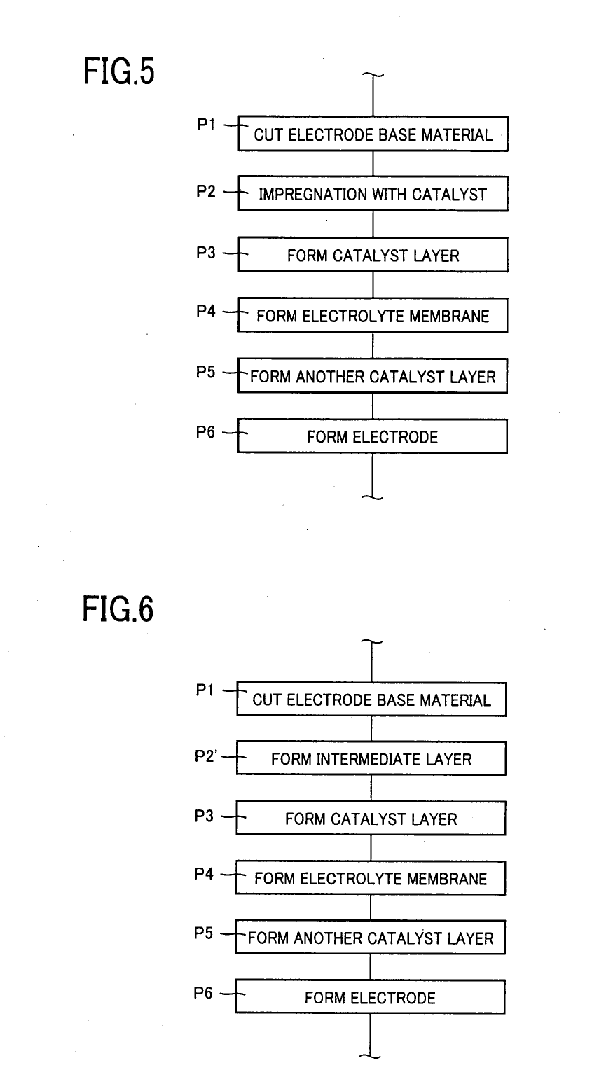

FIG. 5 illustrates a diagram showing an example of the process for manufacturing the MEA 10 in FIG. 2. In FIG. 5, carbon paper is cut to provide base materials for electrodes and to have appropriate dimensions for the MEA to be manufactured of, for instance, about 5 cm in both longitudinal and transverse directions in step P1 for cutting (carbon paper to prepare base materials for electrodes). Conventional carbon papers provided, for instance, for fuel cells by Toray Industries, Inc. are available.

In step P2 for impregnating (the base materials for electrodes with catalyst), the base material for an electrode is impregnated with catalyst impregnated slurry that is prepared in another process, to have about 3 mgPt/cm², and dried at room temperature such as 15° C. in about 18 hours. Step P2 provides the aforementioned gaseous diffusion electrode 18. The catalyst impregnation slurry is prepared in the following process. 1.2 g of Pt/C catalyst, 3.0 g of water and 15.0 of organic solvent are weighed. Conventional Pt/C catalyst such as TEC10E70TPM having 67.5 wt. % of Pt provided by Tanaka Kikinzoku Kogyo K.K. are available. The organic solvent of, for instance, 1-propanol is available. Next, Pt/C catalyst is humidified with water by such as a stirrer in about 300 rpm for a few minutes. And the process provides the aforementioned catalyst impregnation slurry by adding organic solvent and by such as a stirrer in about 300 rpm for about 30 minutes.

In step P3 for forming catalyst layers, catalyst applying slurry prepared in another process than that for the catalyst impregnation slurry is applied onto one surface of the gaseous diffusion electrode 18 impregnated with catalyst and dried in step P2, to obtain about 1 mgPt/cm² by such as screen printing and dried at room temperature of such as 15° C. in about 18 hours. Step P3 provides the gaseous diffusion electrode 18 that is impregnated with catalyst and that is coated with the catalyst layer 14 being formed on its one surface, to be a gaseous diffusion electrode with a catalyst layer. The aforementioned catalyst applying slurry is prepared in the same process for preparing the catalyst impregnation slurry other than replacing the aforementioned organic solvent such as 1-propanol by, for instance, the same amount of Nafion® solution such as DuPont™ DE 520 of 5% concentration.

In step P4 for forming electrolyte membranes, electrolyte solution of, for example, organic solvent and polymer electrolyte that is dissolved in a range of 32-35% in concentration, for instance, about 35% in concentration in the organic solvent is prepared, and the electrolyte solution is applied onto the inner surface of the gaseous diffusion electrode 18 in a range of 3 cm in both longitudinal and transverse directions with the thickness of, for instance, about 75 μm, and dried. This step P4 provides the gaseous diffusion electrode 18 with the electrolyte membrane 12 on the catalyst layer 14. Conventional electrolyte solution that is regulated in concentration by drying, for instance, Nafion® solution such as DuPont™ DE 2020 of 20% concentration on a fluorocarbon resin (such as PTFE) dish at about 80° C. with such as a hot plate to remove a part of the solvent is available. And a product of the electrolyte solution regulated in concentration of desired 32-35% may be also available. For example, 1-propanol is available for the organic solvent. In the above drying treatment, for instance, the applied electrode 18 is dried at room temperature of about 20° C. for about 30 minutes to remove most of the organic solvent, next, heated at about 80° C. for about 30 minutes to thoroughly remove the remainder of the organic solvent and to harden the electrolyte, and furthermore, heated at about 120° C. for about 5 minutes to further harden the electrolyte and, accordingly, to obtain high mechanical strength.

The following reasons limit conditions for the above drying treatment. In order to prevent impregnation of the electrolyte solution into the catalyst layer 14, the drying treatment at room temperature is provided. The electrolyte solution reduced in viscosity and remarkably increased in fluidity at a high temperature without removal of the solvent causes facilitation of impregnation of the electrolyte into the catalyst layer 14 upon immediate drying at 80° C. without removal of the solvent at room temperature. Further heating at about 120° C. after heating at about 80° C. expedites hardening and causes increase of the electrolyte membrane in strength. Heating at about 120° C. is required for sufficient hardening, but long duration at not less than 100° C. causes darkening and lowering of conductivity of the electrolyte membrane. Accordingly, heating at about 80° C. is required in order to shorten duration for heating at not less than 100° C.

Heating at about 120° C. is not requisite treatment, and it is for improvement of the electrolyte membrane in strength. No request of superiority of the electrolyte membrane in mechanical strength allows the process without heating at about 120° C. and with drying treatment at about 80° C. after drying at room temperature.

In step P5 for forming catalyst layers, as in step P3, catalyst slurry is applied onto one surface of the electrolyte membrane 12 and dried to form the catalyst layer 16. In step P6 for forming electrodes, the gaseous diffusion electrode 20 is formed on the catalyst layer 16 to provide the MEA 10. The gaseous diffusion electrode 20 that is made of such as carbon paper as the gaseous diffusion electrode 18 is pressed and heated by such as a hot press with the catalyst layer 16 on it to be bonded together. The gaseous diffusion electrode 20 with such as carbon fibers that are mutually tangled therein is provided, by applying paste constituted of such as synthetic resin fluid and such as carbon fibers diffused in it, onto the catalyst layer 16, and hardening. Adding or replacing with conductive resin preferably permits increase of the gaseous diffusion electrode 20 in conductivity. Application of the paste may be, for instance, achieved by a brush, dip coating or screen printing.

FIG. 6 illustrates a diagram showing a process for manufacturing the MEA 10 in FIG. 3. This process is the same as that in FIG. 5 other than replacing step P2 by step P2′ for forming intermediate layers. It will be referred to only step P2′ in the following.

Step P2′ for forming intermediate layers provides the base material for an electrode, that is, the gaseous diffusion electrode 24, having the intermediate layer 26 on its one surface by applying paste for the intermediate layer in which conductive particles are diffused in fluid resin, and drying. For example, carbon black of such as Vulcan®XC72 of U.S. Cabot Corporation is available for the conductive particles. Such as resol type phenol resin is available for the fluid resin. The phenol resin prepared with water as a solvent is used for it, and the phenol resin prepared with organic solvent may be used. Any appropriate method may be available for applying the paste for the intermediate layer. A screen, for instance, having a frame of about 320×320 mm and a polyester mesh stretched across the frame that has the mesh count of about 100, the fiber (or string) diameter of about 55 μm, the screen thickness of about 95±3 μm, the size of openings of about 199 μm and the opening area of about 61% is available in screen printing. The surface of the base material is applied to reach, for instance, about 100 μm in thickness, and dried at about 20° C. for about two hours.

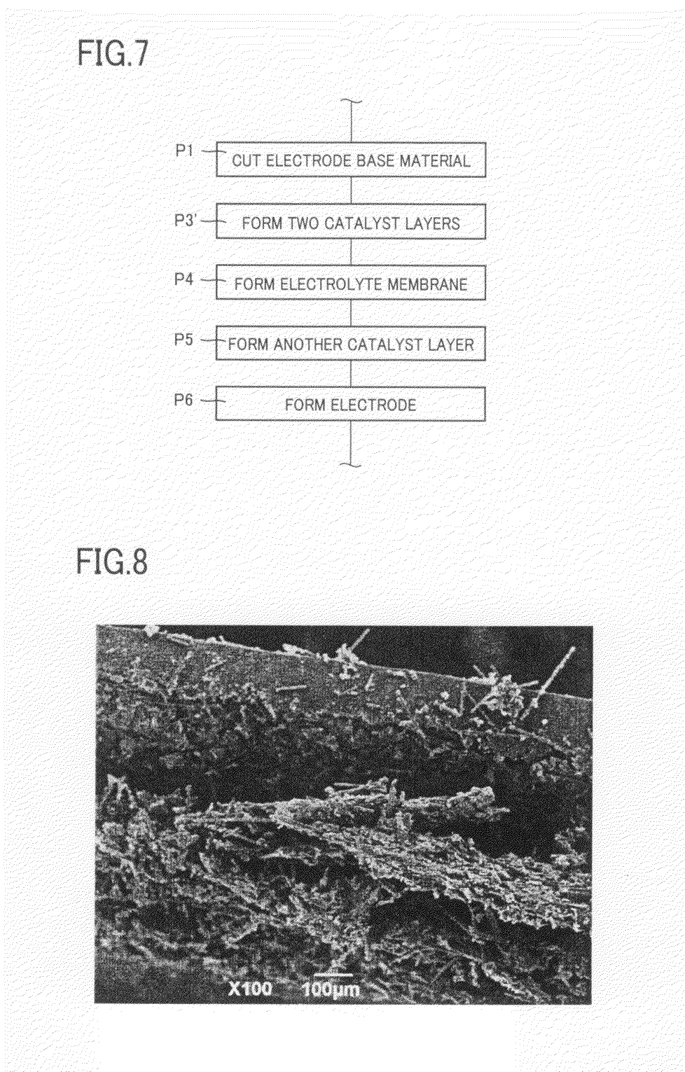

FIG. 7 illustrates a diagram showing a process for manufacturing the MEA 10 in FIG. 4. This process is the same as that in FIG. 5 other than deleting step P2 and replacing step P3 for forming catalyst layers (or for applying catalyst) by step P3′ for forming catalyst layers (or for applying catalyst). In step P3′ for forming double catalyst layers, a process for coating a surface of the base material for an electrode, namely, the gaseous diffusion electrode 30, with catalyst applying slurry and drying it is once repeated, that is, the combination of the treatments of applying and drying is provided twice. The same catalyst applying slurry as that in step P3 is available, and the same drying condition is available.

FIG. 8 illustrates an enlarged sectional view prepared on the basis of an electron micrograph around an interface of the catalyst layer 28 and the electrolyte membrane 12, between step P4 and step P5 in the process for manufacturing the MEA 10 in FIG. 7. The plate-like electrolyte membrane 12 of about 100 μm in thickness that is transversely disposed is shown at the upper part of FIG. 8, and the catalyst layer 28 is shown at the lower half of FIG. 8. A void as a layer formed between the electrolyte membrane 12 and the catalyst layer 28 apparently separates the membrane 12 from the layer 28. Electrolyte included in the electrolyte membrane 12 is not nearly impregnated into the catalyst layer 28.

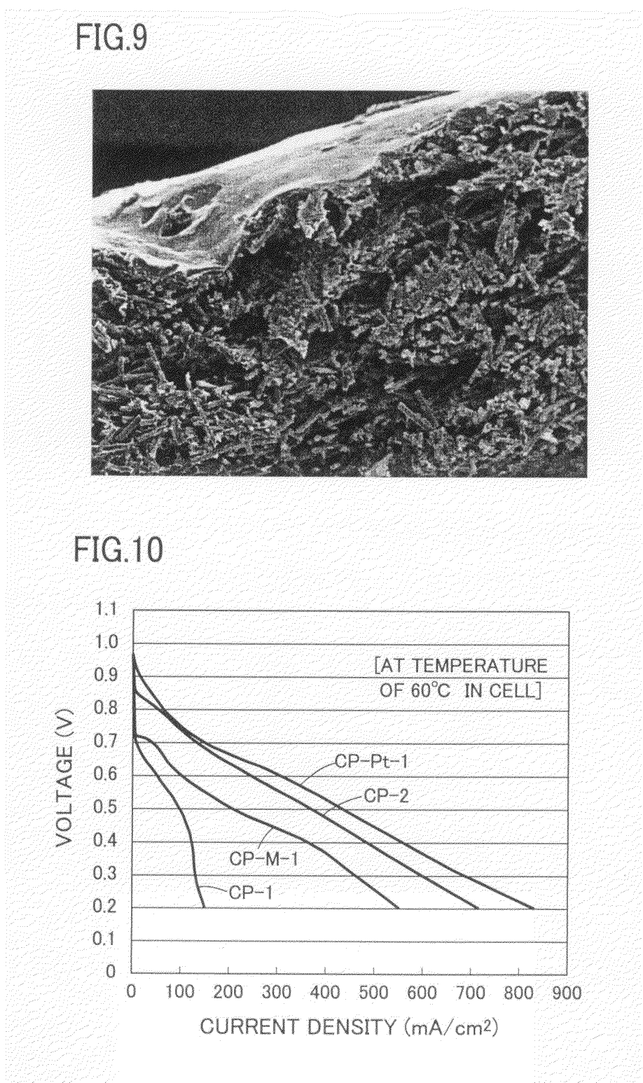

FIG. 9 illustrates an enlarged sectional view prepared on the basis of an electron micrograph around an interface of the catalyst layer 28 and the electrolyte membrane 12 formed on the catalyst layer 28 by once applying onto the base material of an electrode, without step P2 in the process for manufacturing the MEA 10 in FIG. 3. There, electrolyte solution applied on the catalyst layer is impregnated into the catalyst layer to fill voids in the catalyst layer with the electrolyte, that is, voids are “lost”, and in result electrolyte is not nearly remained on the surface of the catalyst layer.

The difference between the structures in FIGS. 8 and 9 is presumed to be caused by higher density of the thicker catalyst layer 28 in FIG. 8 that is formed by two-time applying, than that in FIG. 9 formed by one-time applying. The state that voids in the catalyst layer 28 are “lost” and electrolyte is not nearly remained on the surface of the catalyst layer 28 is caused by easy impregnation of the electrolyte into the catalyst layer 28 of which its surface is porous, and the following easy permeation of the electrolyte into the inside of the layer 28 due to such as capillarity, to reach the back surface of the catalyst layer 28 or the back surface of the base material for an electrode. However, in FIG. 8 the electrolyte solution applied on the catalyst layer 28 that has higher density by two-time applying is remained on the surface because of its difficult impregnation of the solution into the layer 28.

Table 1 shows results of measurement of MEAs in FIGS. 2 to 4 with the conventional MEA. The column of Anode Electrode shows the structures of the gaseous diffusion electrodes 18, 24, 30 functioning as anodes. “CP+Pt/C” in Samples 1 and 2 shows the MEA having carbon paper impregnated with catalyst in step P2 in FIG. 5. “CP+Intermediate Layer” in Samples 3 and 4 shows the MEA having the intermediate layer 26 formed on carbon paper in step P2′ in FIG. 6. “CP Only” in Samples 5 and 6 shows the MEA having carbon paper directly coated with catalyst applying slurry in step P3′ in FIG. 7.

TABLE 1

| | | Times of | | Air Flow Per- | |
|---|---|---|---|---|---|
| | | Applying | | meation Rate | Current |
| | Anode | Anode | | (ml · mm/cm²/ | Density |
| No. | Electrode | Catalyst | Samples | min) | (mA/cm²) |
| 1 | CP + Pt/C | 1 | CP-Pt-1 | 11700 | 305 |
| 2 | CP + Pt/C | 0 | CP-Pt-2 | — | — |
| 3 | CP + | 1 | CP-M-1 | 9950 | 100 |
| | Intermediate | | | | |
| | Layer | | | | |
| 4 | CP + | 2 | CP-M-2 | 7860 | — |
| | Intermediate | | | | |
| | Layer | | | | |
| 5 | CP Only | 1 | CP-1 | 13010 | 50 |
| 6 | CP Only | 2 | CP-2 | 11760 | 245 |

Note:
Values in Air Flow Permeation Rate are measured under 50 kPa, and values in Current Density are measured at 60° C. by the application of a voltage of 0.6 V.

The column of Times of Applying Anode Catalyst shows how many times the slurry is applied on the base material for an electrode (or on the intermediate layer) to form the catalyst layer. Sample 2 without anode catalyst applying, namely, recorded as 0 (zero) times, is the MEA without the catalyst layer 14 and with the electrode layer 12 directly formed on the electrode 18 impregnated with catalyst particles. The column of Samples shows assigned names of the samples reflecting their characteristics and corresponding to Anode Electrode, and numbers for distinction between the same structures. Samples 1, 3 and 6 are the MEAs according to embodiments of the present invention, Sample 5 is the conventional MEA, and Samples 2 and 4 are comparative structures that could not operate as an MEA.

The column of Air Flow Permeation Rate shows flow rate of air permeation through the base material for an electrode having the catalyst layer thereon (before forming of the electrolyte membrane 12), furnishing air to a surface of the electrode having the catalyst layer with a pressure difference of 50 kPa, measured by such as a perm porometer. The column of Current Density shows outputs from each MEA. The current density was measured by a fuel cell measurement system of Toyo Corporation, changing current values by regulation of the load, with the MEA 10 at 60° C., the piping at 80° C., the humidifier chamber at 70° C. and both flow rates of hydrogen (H₂) and air at 500 ml/min. Upon the measurement the MEA is interposed between separators having a serpentine air flow path of 1 mm in width, 1 mm of a pitch and 0.5 mm in depth as one groove, under 3 N·m of clamping pressure on the fuel cell, facing its gaseous diffusion electrode 18 side to the anode and the electrode 20 side to the cathode.

Sample 2 without the catalyst layer 14, having the gaseous diffusion electrode 18 impregnated with catalyst particles, and Sample 4 having the intermediate layer 26 with two catalyst layers thereon in Table 1 were not measured for the MEA characteristics because they have flakes removing in the sintering process after applied with electrolyte.

FIG. 10 illustrates the relationship of the voltage and the current density for plotting results of the above measurement for MEAs. The graph shows that the output of CP-Pt-1 with the electrode 18 impregnated with catalyst particles is the highest and provides the current density of about 305 mA/cm² by 0.6V. The second highest is the output of CP-2 having the catalyst layer 28 by applying catalyst twice and provides the current density of about 245 mA/cm² by 0.6V. The output of CP-M-1 having the intermediate layer 26 slightly exceeds that of the conventional CP-1 and provides the current density of about 100 mA/cm² by 0.6V.

The target current density for practical use of PEFC is desirably set at or over 100 mA/cm² by 0.6V today, and accordingly, the conventional CP-1 does not and could not meet that requirement since it provides the current density of only about 50 mA/cm² by 0.6V. Samples 1 (CP-Pt-1), 3 (CP-2) and 6 (CP-M-1) according to the embodiment all provide the required current density of over 100 mA/cm² as apparent from the above Table 1 and FIG. 10. Especially, MEAs having the electrode 16 impregnated with catalyst particles and having thicker catalyst layer 28 than the conventional, provide remarkably high current density.

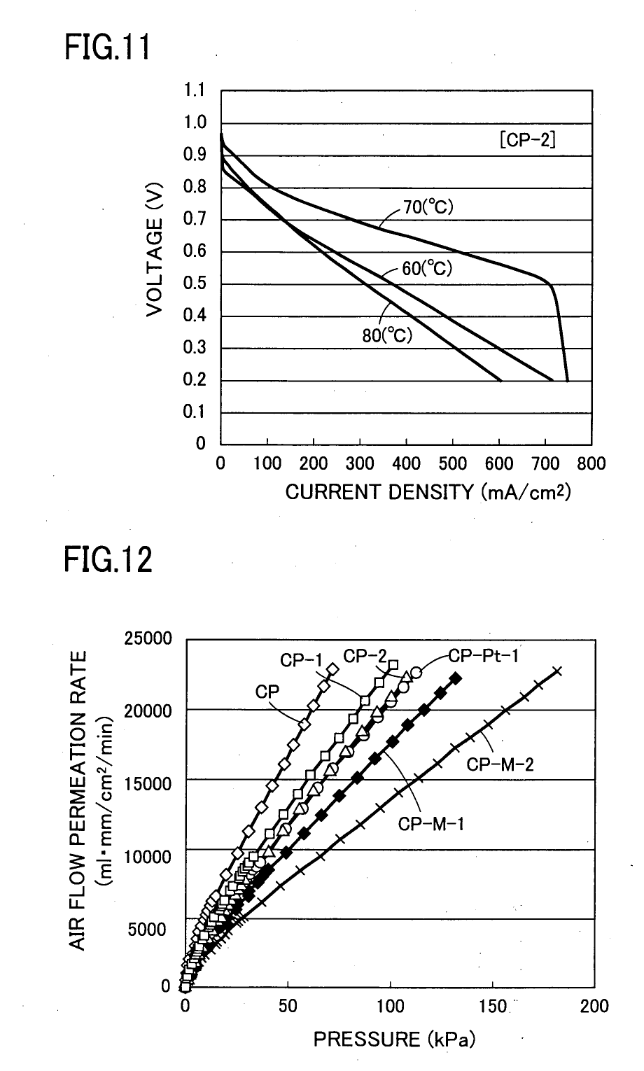

FIG. 11 illustrates the relationship of the voltage and the current density by plotting results of the above measurement for Sample 6 (CP-2), at the temperature of 60° C. in the cell along with those at 70° C. and 80° C. FIG. 11 shows that the very high output of about 520 mA/cm² by 0.6V is provided at the temperature of 70° C. in the cell, whereas almost the same amount of output of about 220 mA/cm² by 0.6V as that at 60° C. is provided at 80° C. Consequently, operation at the temperature of 70° C. in the cell is preferable for the MEA according to the present embodiment.

FIG. 11 also shows the abrupt falling of output in the low voltage area below 0.5 V, at 70° C. This is presumed due to the characteristics of MEA, or collected water as a preventer against action by insufficient capability for removing water in the electrode 20 and the catalyst layer 16 upon increasing of producing water accompanying with the output increase. The above output falling may be in a degree improved by such the conventional way as increasing water repellency by adding such as fluorocarbon resin to the cathode side, namely, the gaseous diffusion electrode 20 side, to increase capability for removing water.

FIG. 12 illustrates the relationship of the pressure on the surface and the air flow permeation rate of each sample of the electrode with the catalyst layer thereon, before forming of the electrolyte layer 12, in Table 1 by plotting results of measurement with a perm porometer. In FIG. 12 a graph labeled CP for a carbon paper having no catalyst layer is a reference, and the other graphs for carbon papers having the catalyst layer are samples according to the embodiments or for comparative purposes. Sample 2 (CP-Pt-2) was not measured because precise measurement of air flow permeation rate is difficult to be achieved due to easiness of removal of Pt/C particles, and furthermore, due to apprehension of dirtiness on and damages to instruments for measurement.

FIG. 12 shows graphs of CP of a carbon paper only, the conventional CP-1 having the electrode with one catalyst layer, CP-2 having the electrode with two catalyst layers, CP-Pt-1 having the electrode impregnated with catalyst, CP-M-1 and CP-M-2 having the intermediate layer 26, in a descending order of the air flow permeation rate.

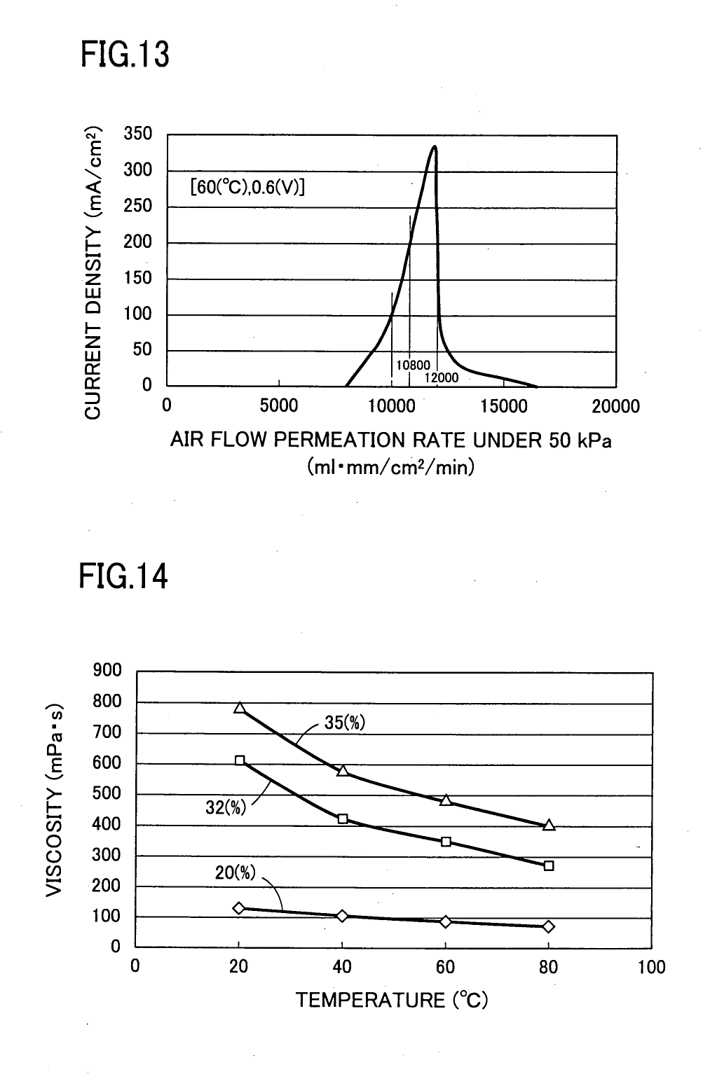

FIG. 13 illustrates the relationship of the air flow permeation rate and the current density of the above measurement under the pressure of 50 kPa. A plurality of all types of structures for the samples contribute to form the graph. FIG. 13 shows remarkable ascending in the current density beginning at about 10000 ml·mm/cm²/min of the air flow permeation rate, and abrupt descending in the current density beginning at about 12000 ml·mm/cm²/min. The graph exceeds 100 mA/cm² by 0.6V in the range of about 10000-12000 ml·mm/cm²/min, and exceeds 200 mA/cm² in the range of about 10800-12000 ml·mm/cm²/min. And it is found that the graph reaches the maximum current density of about 330 mA/cm² at about 11500 ml·mm/cm²/min. The graph teaches that the air flow permeation rate of the electrode with the catalyst layer before forming of the electrolyte layer 12 is required to be in the range of about 10000-12000 ml·mm/cm²/min for high output.

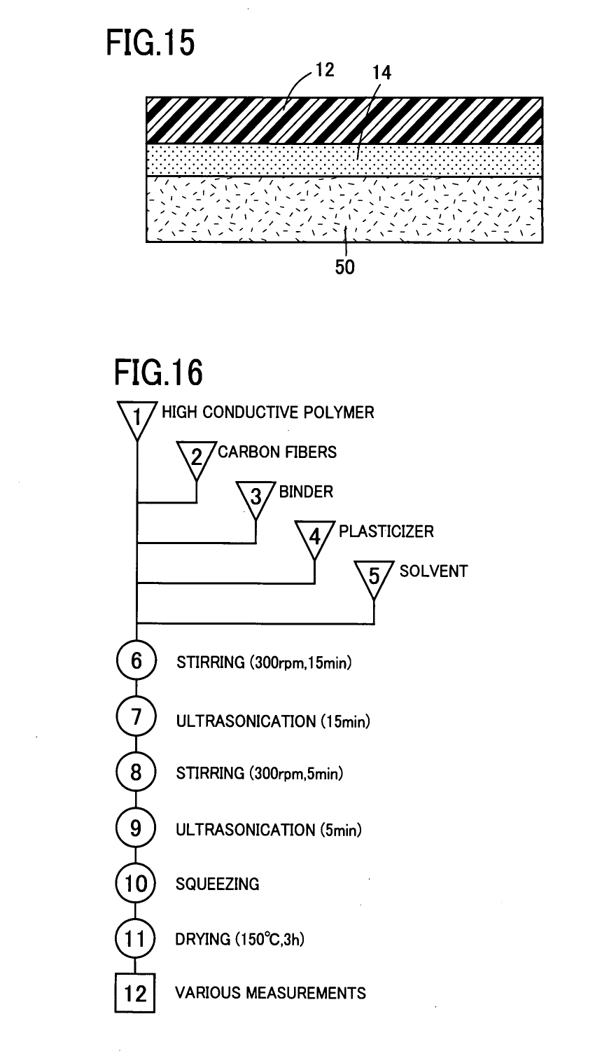

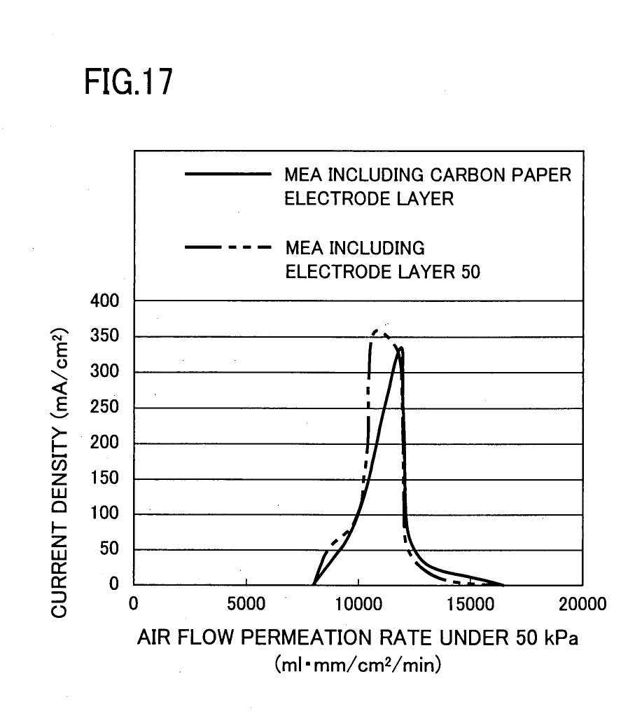

Table 2 and FIG. 14 illustrate the relationship of concentration, temperature and viscosity of the electrolyte solution using Nafion® electrolyte. The higher the concentration of the electrolyte solution is, the higher the viscosity also tends to be. The solution of about 20% has low viscosity of about 130 mPa·s at 20° C., and that of over 32% has the viscosity of over 600 mPa·s at 20° C. It should be noted that the electrolyte solution of high viscosity shows abrupt falling in viscosity according to a rise in temperature.

TABLE 2

| Nafion ® | Temperature | Viscosity |
|---|---|---|
| Concentration | (° C.) | (mPa · s) |
| 20% | 20 | 130 |
| | 40 | 105 |
| | 60 | 87 |
| | 80 | 71 |
| 32% | 20 | 312 |
| | 40 | 424 |
| | 60 | 350 |
| | 80 | 272 |
| 35% | 20 | 780 |
| | 40 | 576 |
| | 60 | 480 |
| | 80 | 402 |

The viscosity of the electrolyte solution and the drying condition after applying the solution in the previously described manufacturing process are determined on the basis of such as the above measurement result in Table 2. Removal of most of the solvent at 20° C. is required in order to prevent impregnation of the electrolyte solution into such as the catalyst layer due to falling in viscosity by a rise in temperature. It was difficult to sufficiently restrain impregnation of the electrolyte solution of the viscosity of less than 600 mPa·s, even if, for instance, the MEA has the structure including the electrode impregnated with catalyst, one has the structure including the intermediate layer, or one has the structure including the thick catalyst layer. The solution concentration over 32% causes viscosity over 600 mPa·s and can sufficiently restrain impregnation.

However, viscosity of the electrolyte solution in concentration over 35%, for instance, of and over 37% abruptly rises, and accordingly, the electrolyte solution hardens, for instance, in the process to regulate viscosity by removing the solvent from the previously described solution in concentration of 20%. For that reason, the solution in concentration up to 35% is available, and that over 35% is not available.

The gaseous diffusion electrode 18, 20, 24, 30 may be replaced by a gaseous diffusion electrode 50 that has another structure. FIG. 15 illustrates the MEA 10 having the gaseous diffusion electrode 50 according to another embodiment of the present invention.

TABLE 3

| No. | Material | Name of Substance | Amount (g) |
|---|---|---|---|
| 1 | High conductive polymer | Polyethylenedithiophene | 15 |
| 2 | Carbon fiber | (Fiber length: 120 μm) | 3 |
| 3 | Binder | Resol resin | 0.5 |
| 4 | Plasticizer | Ethylene glycol | 0.75 |
| 5 | Solvent | 1-Propanol | 10 |

FIG. 16 illustrates a diagram showing an example of the process for manufacturing the gaseous diffusion electrode 50. The gaseous diffusion electrode 50 may, for instance, be manufactured by the treatments in the process shown in FIG. 16. A base material for the gaseous diffusion electrode 50 is prepared by mixing materials, for instance, of Nos. 1-5 listed in Table 3, by a predetermined amount also listed in Table 3. The prepared base material is stirred at the rotational speed of about 300 rpm for 15 minutes, then treated by ultrasonication for 15 minutes, stirred again at the rotational speed of about 300 rpm for five minutes, then treated again by ultrasonication for five minutes. Next, the prepared base material, the slurry, is poured onto, for instance, a fluorocarbon resin (PTFE) sheet on which a metal mask of about 1 mm in thickness is disposed, the poured slurry is squeezed, dried at 150° C. for three hours, and the resin sheet is removed to achieve the gaseous diffusion electrode 50. The thickness of the dried base material reduces to about 200 μm to be the electrode 50. Applications of catalyst and electrolyte are performed in the same way as the conventional CP-1 (Sample 5) having the electrode with the catalyst layer. The air flow permeation amount is appropriately regulated by controlling the viscosity of catalyst slurry.

FIG. 17 illustrates the relationship of the air flow permeation rate and the current density of measurement of the MEA 10 having the gaseous diffusion electrode 50, compared with the MEA 10 having carbon paper electrode layer. They were measured under the pressure of 50 kPa and by the voltage of 0.6 V. FIG. 17 apparently shows that the measurement of the MEA 10 having the gaseous diffusion electrode 50 results in the substantially similar graph to that of the MEA 10 having the carbon paper electrode. That is, the MEA 10 having the gaseous diffusion electrode 50 can provide the substantially similar output to that having the carbon paper electrode, by the graph showing the substantially similar current density in the substantially similar range of air flow permeation amount.

As described above, according to the present embodiment, the MEA is manufactured to have the gaseous diffusion electrode 18 impregnated with catalyst particles, to have the porous intermediate layer having conductive particles bonded to by synthetic resin on the gaseous diffusion electrode 24, or to have thick catalyst layer 28 by applying twice, in order to regulate air flow permeation rate of the electrode with the catalyst layer in the range of about 10000-12000 ml·mm/cm²/min. Consequently, upon forming the electrolyte membrane 12 by applying the electrolyte solution thereto, impregnation of the electrolyte solution into the catalyst layers 14, 28 is preferably restrained, and accordingly, lowering in gaseous diffusion performance of the catalyst layers 14, 28 and the electrodes 18, 24, 30 and lowering in reactivity with catalyst are preferably restrained to provide a laminated layer fuel cell of high output.

It is to be understood that the present invention may be embodied with other changes, improvements, and modifications that may occur to a person skilled in the art without departing from the scope and spirit of the invention defined in the appended claims.

What is claimed is:

1. A laminated layer fuel cell including a solid polymer electrolyte layer, a pair of catalyst layers, and a pair of gaseous diffusion electrode layers, one of the pair of catalyst layers and one of the pair of gaseous diffusion electrode layers being formed on one side of the solid polymer electrolyte layer, and the other of the pair of catalyst layers and the other of the pair of gaseous diffusion electrode layers being formed on the other side of the solid polymer electrolyte layer,
wherein the one of the pair of catalyst layers and the one of the pair of the gaseous diffusion electrode layers constitute a composite electrode layer, and the composite electrode layer has an amount in a range of 10000 to 12000 ml·mm/cm²/min of air flow permeation in the thickness direction in a dried state.

2. A method for manufacturing a laminated layer fuel cell including a solid polymer electrolyte layer, a pair of catalyst layers, and a pair of a gaseous diffusion electrode layers, one of the pair of catalyst layers and one of the pair of gaseous diffusion electrode layers being formed on one side of the solid polymer electrolyte layer, and the other of the pair of catalyst layers and the other of the pair of gaseous diffusion electrode layers being formed on the other side of the solid polymer electrolyte layer, the method comprising the steps of:
preparing a base material for the gaseous diffusion electrode layer which is made of porous conductive material to form the one of the pair of gaseous diffusion electrode layers;
forming the catalyst layer to form a base material for the gaseous diffusion electrode layer accompanied with the one of the pair of catalyst layers on its one side, so as to have an amount in a range of 10000 to 12000 ml·mm/cm²/min of air flow permeation in the thickness direction in a dried state; and
forming the solid polymer electrolyte layer by applying electrolyte solution onto the catalyst layer of the base material for the electrode layer accompanied with the one of the pair of catalyst layers.

3. The method according to claim 2, wherein the one of the pair of gaseous diffusion electrode layer is formed in heat treatment of slurry including carbon fiber, conductive polymer and thermosetting resin at or below 200° C.

4. The method according to claim 2, wherein the electrolyte solution has viscosity in the range of 600 to 1000 mPa·s.

5. The method according to claim 2, wherein the electrolyte solution applied onto the catalyst layer is treated in drying treatment for a predetermined period of time at room temperature, and then, is heated to harden the electrolyte solution at a higher temperature, in the step of forming the solid polymer electrolyte layer.

6. The method according to claim 2, wherein the step of forming the catalyst layer includes the steps of:
impregnating the base material with a diffusion solution for impregnating with catalyst in which catalyst material for forming the catalyst layer is diffused; and
applying the diffusion solution for impregnating with catalyst in which the catalyst material is diffused in solution including a predetermined electrolyte, onto the side of the base material which is impregnated with the catalyst, to form the one of the pair of catalyst layers.

7. The method according to claim 2, wherein the step of forming the catalyst layer includes the steps of:
forming an intermediate layer having a smaller diameter of a pore than that of the base material for an electrode, by applying a conductive particle diffusion solution in which a predetermined conductive particle is diffused in fluid synthetic resin, onto the side of the base material for an electrode; and
forming the one of the pair of catalyst layers, by applying the diffusion solution for applying catalyst in which the catalyst material for forming the catalyst layer is diffused in solution including a predetermined electrolyte, onto a surface of the intermediate layer.

8. The method according to claim 2, wherein the step of forming the catalyst layer includes the step of:
forming the one of the pair of catalyst layers, by more than once applying the diffusion solution for applying catalyst in which the catalyst material for forming the catalyst layer is diffused in solution including a predetermined electrolyte, onto the side of the base material for an electrode, and drying the base material for an electrode.
